(19) United States
(12) Patent Application Publication
(10) Pub. No.: US 2024/0364119 A1
(43) Pub. Date: Oct. 31, 2024

(54) Battery Life Balancing Using Hard Disconnect of Parallel Batteries

(71) Applicant: Smartville, Inc., Carlsbad, CA (US)

(72) Inventor: Willam von Novak, Carlsbad, CA (US)

(21) Appl. No.: 18/600,400

(22) Filed: Mar. 8, 2024

Related U.S. Application Data
(60) Provisional application No. 63/450,917, filed on Mar. 8, 2023.

(51) Int. Cl. H02J 7/00

(52) U.S. Cl. CPC H02J 7/0013; H02J 7/00047; H02J 7/0048

(57) ABSTRACT

A battery storage system comprising one or more batteries having capacity differences between batteries and at least one relay, wherein the at least one relay disconnects or reconnects the one or more batteries from the system. The one or more batteries comprise batteries with more capacity and batteries with less capacity relative to an average capacity across the battery storage system.

### FIELD OF THE INVENTION

This application relates generally to the field of batteries, specifically, for materials and methods used to improve life balancing of batteries within large battery systems.

### BACKGROUND OF THE INVENTION

Electric vehicle (EV) batteries are used to power the drivetrains of fully electric vehicles. After approximately a decade of use, most EV batteries expect average a loss of capacity of around 20%. While this degradation may be suboptimal from a vehicle operational perspective, this means that the life of those used EV batteries still retain around 80% of their original capacity.

Second life EV batteries are a critical source of battery storage for large scale battery energy storage systems (BESS). Within five years, used EV batteries alone will be able to provide 100% of our grid energy storage needs, without using any additional raw materials. This will also postpone the need for recycling of these batteries by years, allowing recycling facilities more time to ramp up.

To enable this, large parallel arrays of EV batteries must be connected to a common bus, so that their storage capacity can be easily scaled up to meet the needs of utility-scale systems. Ideally, all batteries start out at the same state of health and decline at the same rate, so that end-of-life is reached at the roughly the same time for all batteries. This maximizes battery use.

However, in actual use, this does not always happen, and hence a mechanism to “force” some batteries to age faster can be utilized to cause them all to converge towards the same state of health (SOH) and meet the minimum SOH at the end of their life. If this occurs, battery life (and total return on investment) is maximized.

The state of the art is lacking in terms of viable options for maximizing battery life through balancing a plurality of batteries such that they all achieve the same SOH by the end of their life. The present invention describes materials and methods used to achieve a preferred solution to the problems within the art, specifically, through use of hard disconnection of weaker batteries, then reconnection by matching voltage state to system voltage state during cycling.

### SUMMARY OF THE INVENTION

The present invention provides for a battery storage system comprising one or more batteries having capacity differences between batteries and at least one relay, wherein the at least one relay disconnects or reconnects the one or more batteries from the system. Preferably, the one or more batteries comprise batteries with more capacity and batteries with less capacity relative to an average capacity across the battery storage system. Most preferably, the at least one relay is an internal relay attached to each of the one or more batteries. Optionally, the batteries with less capacity relative to the average capacity are disconnected from the system through the internal relay. Most preferably, after the batteries with less capacity are disconnected, the battery storage system is cycled, after which time the batteries with less capacity are reconnected to the system when voltage and state of charge readings match that of the system. Optionally, the system can intelligently disconnect and reconnect the batteries with less capacity such that the reconnection occurs when voltage and state of charge of the batteries with less capacity are identical or close to identical with that of the system.

In another aspect, the present invention provides for a battery storage system that allows connection of batteries of different charge states without having to first match their states of charge through at least one external component selected from the group consisting of external charger and external load.

### BRIEF DESCRIPTION OF THE DRAWINGS

The novel features of the present invention are set forth herein embodied in the form of the claims of the invention. Features and advantages of the present invention may be best understood by reference to the following detailed description of the invention, setting forth illustrative embodiments and preferred features of the invention, as well as the accompanying drawings, of which:

FIG. 1 shows a simple balancing example of the preferred system of the present invention.

FIG. 2 shows a battery system having battery 2 being forced to “sit out.”

FIG. 3 shows a battery system with a plurality of batteries, a charger and a load (an inverter.)

### DETAILED DESCRIPTION OF THE INVENTION

Described herein are methods, devices and systems specifically configured to increase the capacity of a battery system in order to position many other smaller batteries in parallel. These smaller batteries may be single cells, or multi-cell batteries. Preferably, these smaller batteries are 1S batteries (only one cell, either by itself or paralleled) or nS batteries (where n cells, or n paralleled sets of cells are put in series).

Paralleling batteries is relatively straightforward but, once connected, all batteries are forced to cycle a similar way. The result of this may result in a variety of outcomes. For example, if a battery's aging causes a significant increase in equivalent series resistance (ESR) but a minimal change in capacity, then older cells will share less total current. This is due to their higher resistance to the battery bus and translates to those batteries participating less in high power demands (or high-power charges) and will, therefore, age more slowly. This will tend to age the newer batteries faster, gradually bringing everything into SOH balance, resulting in a good outcome.

On the other hand, if a battery's aging causes a significant decrease in capacity, but a minimal change in ESR, then this effect will not be seen or expressly observed. As a result, batteries will continue to age at similar rates, thus keeping low SOH batteries at a low SOH and higher SOH batteries at a higher SOH.

In addition, since relying on ESR results in a slow rebalancing of SOH, the battery's SOH may not converge before the end of life of the weakest battery is reached even if there is a good correlation between SOH and ESR.

Since batteries age differently based on chemistry, life history, thermal design, etc., it can be difficult to design a battery system that ensures the lifetime of all batteries in a given system is maximized (i.e. arrive at the minimum SOH at the same time).

### Evaluation of SOH Mismatch in a System

The first step is to evaluate the magnitude of the mismatch of the SOH. SOH can be determined by the following methods:
1. ESR calculation: In this method, step changes in charge or load are applied to the battery. Since battery voltages do not change instantaneously, any resulting increase/decrease in battery voltage is proportional to the battery's internal resistance, given by ΔR=ΔV/ΔI. This is often a proxy for battery health.
2. Cycle and record via current accumulation: By charging and discharging to a battery's high and low battery limits, measuring (and accumulating) the total current capacity (measured in amp-hours) can be determined.
3. Stored SOH data: In some cases, the capacity/health of the battery is known beforehand, and can be stored in the system.

Once the SOH of all batteries is determined, the system can proceed in making decisions to “age” certain batteries more quickly than others, thereby bringing all batteries to a similar SOH.

### Prior Art: Individual Control of Batteries

It is crucially important to converge the SOH of all batteries in order to maximize battery system life.

The system can be designed to dedicate one inverter or DC/DC converter to each battery. This allows each battery to contribute a programmed amount of current to a discharge, and likewise absorb a programmed amount of current during a charge. By programming the inverters/converters to drive the higher SOH batteries harder during both charges and discharges, the higher SOH batteries are aged faster. This gives precise control of battery aging, but comes at a high cost, though, since having an inverter/converter per battery is a costly proposition. For many applications this higher cost may be prohibitive.

### EXAMPLES

### Case 1 Study: Hard Disconnect of Batteries

The solution described herein uses a much simpler and cheaper method. Instead of individual control of battery currents, weaker batteries are forced to “sit out” cycles-they are simply disconnected via their own internal relays, the battery system is cycled without those weaker batteries, and then the weaker batteries are reconnected when voltage/state of charge again matches the formerly disconnected battery.

The timing of this is important. If a weaker battery is disconnected at a high state of charge (say 95% SOC and 390 volts) and reconnected when the system is at a low state of charge (e.g. 5% and 320 volts) then there will be very large currents passed through the system as the 95%-SOC weaker battery attempts to equalize with the 5%-SOC battery system.

Therefore, a critical part of this concept is a system that intelligently disconnects and reconnects the weaker battery so that it reconnects when its voltage and SOC is identical, or nearly identical, to that of the system.

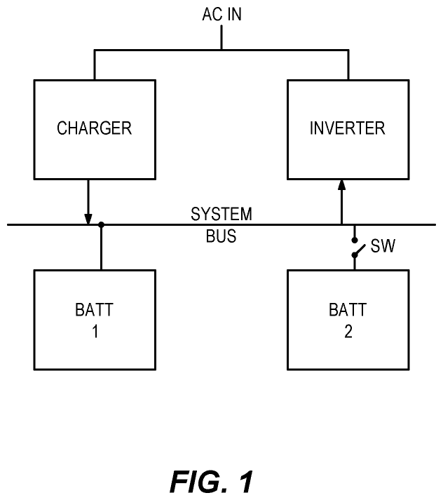

An example of this in action is shown at FIG. 1. The system in this case is simple: one permanently connected battery and one switched battery. A charger can charge the battery from the AC grid, and an inverter can feed back power to the AC grid and thus discharge the battery system.

As shown in FIG. 1, it is assumed that battery 1 is strong (has a high SOH) and battery 2 is weak (has a low SOH.) The system is used in a grid storage application, and is regularly cycled from 90% SOC to 10% SOC and back again. Battery 2 is disconnected at 80% SOC and forced to “sit out” a full cycle. The battery system (minus battery 2) is then discharged to 20% then recharged. As it passes 80% of charge, the battery is reconnected (though this assumes that SOC and voltage track each other closely, which is usually the case. When this is not the case, voltage must drive the decision to reconnect, since it is differential voltage that drives current flow between batteries). Since the voltages match at this point, little extra current flows. The result of this is that battery 2 sees much shallower cycles than battery 1 does, and thus battery 1 is aged more quickly than battery 2.

Case 2 Study: Battery System with Battery 2 being Forced to “Sit Out”

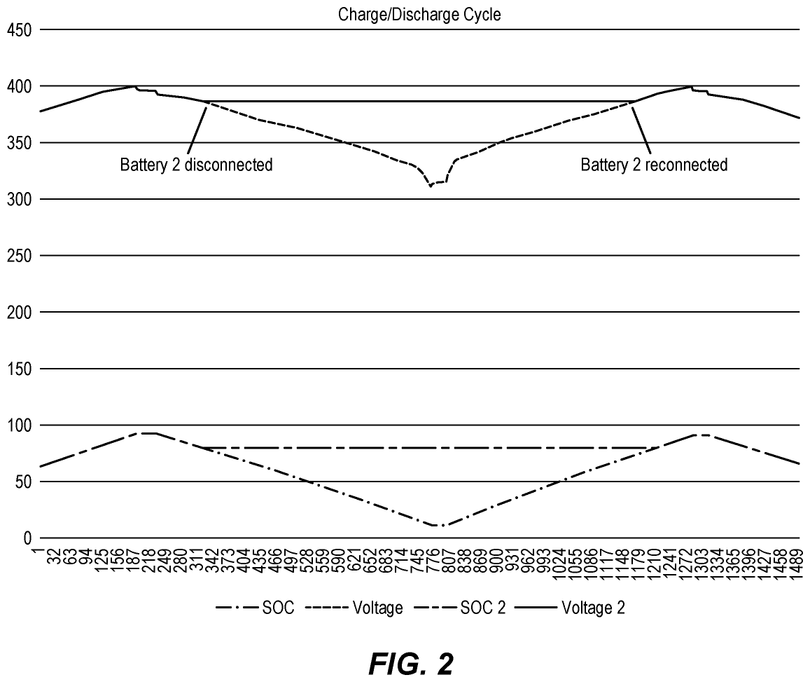

In this case, the weaker battery is forced to “sit out” an integer number of cycles (FIG. 2). An algorithm will decide how many cycles to have it “sit out,” based on how quickly the battery must be brought to the same SOC as all the other batteries. To do this, a maximum period (representing a number of cycles) will be chosen based on the granularity of the balancing adjustment desired, and then the duty cycle (representing the amount of time the battery is connected to the battery system) will be chosen to achieve the desired “sit out” period.

As an example, Table 1 below assumes a maximum duty cycle of 10 cycles. With that maximum, and a judicious choice of actual period and duty cycle, up to 32 levels of “sit out” can be achieved (see Table 1) A higher level of “sit out” will bring the system into balance more rapidly, while a lower level of “sit out” will take longer. Usually, it will be sufficient to ensure that all batteries reach the minimum SOH at the same time, so the degree of “sit out” required will depend on how “out of balance” the various SOH's are relative to the system.

TABLE 1
“Sit out” ratios based on a maximum duty cycle of 10 cycles

| Duty cycle | Cycle length | Ratio |
|---|---|---|
| 1 | 10 | 0.100 |
| 1 | 9 | 0.111 |
| 1 | 8 | 0.125 |
| 1 | 7 | 0.143 |
| 1 | 6 | 0.167 |
| 1 | 5 | 0.200 |
| 2 | 9 | 0.222 |
| 1 | 4 | 0.250 |
| 2 | 7 | 0.286 |
| 3 | 10 | 0.300 |
| 1 | 3 | 0.333 |
| 3 | 8 | 0.375 |
| 2 | 5 | 0.400 |
| 3 | 7 | 0.429 |
| 4 | 9 | 0.444 |
| 1 | 2 | 0.500 |
| 5 | 9 | 0.556 |
| 4 | 7 | 0.571 |
| 3 | 5 | 0.600 |
| 5 | 8 | 0.625 |
| 2 | 3 | 0.667 |
| 7 | 10 | 0.700 |
| 5 | 7 | 0.714 |
| 3 | 4 | 0.750 |
| 7 | 9 | 0.778 |
| 4 | 5 | 0.800 |
| 5 | 6 | 0.833 |
| 6 | 7 | 0.857 |
| 7 | 8 | 0.875 |
| 8 | 9 | 0.889 |
| 9 | 10 | 0.900 |
| 10 | 10 | 1.000 |

Additionally, the algorithm will often have to ensure that a minimum number of batteries is connected to the system at a given time to ensure that the maximum C rate is not exceeded. For example, if a battery system is designed to provide C/4 discharge rates, and the maximum charge/discharge rate of each individual battery must not exceed C/2, then no more than half the weaker batteries can be disconnected at any given time. The algorithm will have to take that into account when scheduling which batteries “sit out” a given cycle.

### Case 3 Study: Reconnect of Dissimilar SOC Batteries

This solution can also be used to solve a related problem—that of paralleling of large numbers of batteries. If the batteries are at different SOC/voltages, then connecting them will cause large (and potentially damaging) current flows. By using the method described above (i.e. charging or discharging the system until the system voltage/SOC matches the new battery voltage/SOC) this problem can be alleviated.

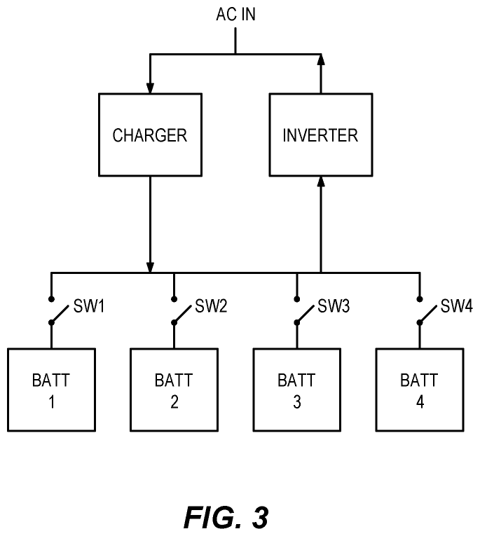

This process is shown at FIG. 3 is for a system of 4 batteries. Each battery has a switch on its output. Note that this can be an external switch or an internal contactor already present in the battery. A charger allows charging the system and an inverter allows discharge of the battery back to the grid.

One battery is connected to the system bus initially. At that point the system bus becomes the battery 1 voltage. The system is then charged and discharged to bring the bus voltage up and down. When the bus voltage matches the voltage of the next battery, it is connected, then it along with the system bus is moved up and down in voltage to match the next battery. An example process is shown below at Table 2 with four disparate-voltage batteries.

TABLE 2
Connection process for battery connection

| | Red = corresponding battery switch closed | | | | |
|---|---|---|---|---|---|
| | Battery 1 | Battery 2 | Battery 3 | Battery 4 | |
| Action | Voltage | voltage | voltage | voltage | Notes |
| Idle | 340 | 360 | 380 | 320 | All batteries disconnected |
| Idle | 340 | 360 | 380 | 320 | Battery 1 connected to system |
| Charge | 350 | 360 | 380 | 320 | System voltage rising |
| Charge | 360 | 360 | 380 | 320 | System voltage now matches batt 2 |
| Charge | 360 | 360 | 380 | 320 | Batt 2 connected to system |
| Charge | 370 | 370 | 380 | 320 | System voltage rising |
| Charge | 380 | 380 | 380 | 320 | System voltage now matches batt 3 |
| Charge | 380 | 380 | 380 | 320 | Batt 3 connected to system |
| Idle | 380 | 380 | 380 | 320 | Further charging now does not help |
| Discharge | 360 | 360 | 360 | 320 | System discharged to “meet” batt 4 voltage |
| Discharge | 340 | 340 | 340 | 320 | Discharge |
| Discharge | 320 | 320 | 320 | 320 | System voltage now matches batt 4 |
| Discharge | 320 | 320 | 320 | 320 | Batt 4 connected to system |
| Idle | 320 | 320 | 320 | 320 | All batteries connected |

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features. As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those of in the art upon reviewing the above description. The scope of the invention should therefore, be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

We claim:

1. A battery storage system comprising one or more batteries having capacity differences between batteries and at least one relay, wherein the at least one relay disconnects or reconnects the one or more batteries from the system.

2. The system of claim 1, wherein the one or more batteries comprise batteries with more capacity and batteries with less capacity relative to an average capacity across the battery storage system.

3. The system of claim 1, wherein the at least one relay is an internal relay attached to each of the one or more batteries.

4. The system of claim 1, wherein the one of more batteries having less capacity relative to the average capacity are disconnected from the system through the internal relay.

5. The system of claim 1, wherein the batteries with less capacity are disconnected, the battery storage system is cycled, after which time the batteries with less capacity are reconnected to the system when voltage and state of charge readings match that of the system.

6. The system of claim 1, wherein the system can intelligently disconnect and reconnect the batteries with less capacity such that the reconnection occurs when voltage and state of charge of the batteries with less capacity are identical or close to identical with that of the system.

7. A battery storage system that allows connection of batteries of different charge states without having to first match their states of charge through at least one external component selected from the group consisting of external charger and external load.
